(19) United States
(12) Patent Application Publication
(10) Pub. No.: US 2020/0007944 A1
(43) Pub. Date: Jan. 2, 2020

(54) METHOD AND APPARATUS FOR DISPLAYING INTERACTIVE ATTRIBUTES DURING MULTIMEDIA PLAYBACK

(71) Applicant: YOUKU INTERNET TECHNOLOGY (BEIJING) CO., LTD., Dongcheng District, Beijing (CN)

(72) Inventors: Diyang HAN, Hangzhou (CN); Yi FANG, Hangzhou (CN); Fei HONG, Hangzhou (CN); Feng ZHANG, Hangzhou (CN)

(21) Appl. No.: 16/482,932

(22) PCT Filed: Nov. 24, 2017
(86) PCT No.: PCT/CN2017/112790

§ 371 Date: Aug. 1, 2019

(30) Foreign Application Priority Data
Mar. 2, 2017 (CN) 201710121354.5

(51) Int. Cl. H04N 21/472; H04N 21/475; H04N 21/488; H04N 21/8545; G06F 3/0482; H04N 21/258

(52) U.S. Cl. CPC H04N 21/47217; H04N 21/4756; H04N 21/25841; H04N 21/8545; G06F 3/0482; H04N 21/4884

(57) ABSTRACT

The disclosure relates to methods and apparatuses for displaying interactive attributes. The method comprises: determining interactive attributes regarding a multimedia resource based on interactive data of a user during playback of the multimedia resource; generating visualized interactive information based on the interactive attributes; and displaying the visualized interactive information. According to embodiments of the disclosure, interactive attributes can be determined based on interactive data of a user during playback of a multimedia resource, and then visualized interactive information is generated and displayed, to clearly and intuitively display interactions, improve the display effect, and enhance user experience.

### CROSS-REFERENCE TO RELATED APPLICATIONS

This application is the National Stage of, and claims priority to, Int'l. Appl. No. PCT/CN17/112790, filed Nov. 24, 2017, which claims priority to Chinese Patent Application No. 201710121354.5 filed on Mar. 2, 2017, both of which are incorporated herein by reference in their entirety.

### BACKGROUND

### Technical Field

The disclosure relates to the computer technologies field, and in particular, to method and apparatuses for displaying interactive attributes.

### Description of the Related Art

During playback of a multimedia resource, a user can perform interactions, such as making comments, giving likes, and forwarding, on the multimedia resource. Using current technologies, various interactions performed by the user on the multimedia resource can be shared and displayed. However, during sharing and display using existing technologies, interactions are simply superimposed on the multimedia resource and sent to a receiving user, which cannot meet the user's needs. Therefore, it is necessary to provide a display method and apparatus that can clearly and intuitively share user interactions.

### SUMMARY

In view of this, the disclosure provides methods and apparatuses for displaying interactive attributes, in which visualized interactive information can be displayed based on interactive attributes, to clearly and intuitively display interactions, improve the display effect, and enhance user experience.

According to one aspect of the disclosure, a method for displaying interactive attributes is provided, comprising: determining interactive attributes regarding a multimedia resource based on interactive data of a user during playback of the multimedia resource; generating visualized interactive information based on the interactive attributes; and displaying the visualized interactive information.

For the method described above, in one embodiment, the interactive data comprises comment icons input by the user during playback of the multimedia resource and corresponding input time; and the interactive attributes comprise at least one of an input time distribution of a first comment icon or an overall input time distribution for multiple comment icons, wherein the first comment icon is any comment icon in multiple comment icons.

For the method described above, in one embodiment, the generating visualized interactive information based on the interactive attributes comprises at least one of: generating, based on the interactive attributes, an overall icon input time density graph for multiple comment icons or a first icon input time density graph for the one or a plurality of first comment icons; and the displaying the visualized interactive information comprises at least one of: displaying the overall icon input time density graph or the first icon input time density graph.

For the method described above, in one embodiment, the generating visualized interactive information based on the interactive attributes comprises: determining, based on the interactive attributes, a second comment icon having the greatest input time density in a first time interval during playback of the multimedia resource; and determining a second icon input time density graph for the second comment icon for multiple first time intervals during playback of the multimedia resource; and the displaying the visualized interactive information comprises: displaying the second icon input time density graph.

For the method described above, in one embodiment, the displaying the second icon input time density graph comprises: displaying, for each first time interval in the second icon input time density graph, a second comment icon corresponding to the first time interval and an input time density of the second comment icon.

For the method described above, in one embodiment, the method further comprises: if the displayed visualized interactive information is triggered, cause playing progress of the multimedia resource to jump to a time point corresponding to a location where the visualized interactive information is triggered.

For the method described above, in one embodiment, the displaying the visualized interactive information comprises at least one of the following display modes: displaying the visualized interactive information in a superimposed manner in a multimedia resource playing region; displaying the visualized interactive information in a multimedia resource playing progress control region; and displaying the visualized interactive information in a region other than the multimedia resource playing region and the multimedia resource playing progress control region.

For the method described above, in one embodiment, the comment icons comprise comment icons in bullet screens.

According to another aspect of the disclosure, an apparatus for displaying interactive attributes is provided, comprising: an interactive attribute determining module, configured to determine interactive attributes regarding a multimedia resource based on interactive data of a user during playback of the multimedia resource; an interactive information generation module, configured to generate visualized interactive information based on the interactive attributes; and an interactive information display module, configured to display the visualized interactive information.

For the apparatus described above, in one embodiment, the interactive data comprises comment icons input by the user during playback of the multimedia resource and corresponding input time; and the interactive attributes comprise at least one of an input time distribution of a first comment icon or an overall input time distribution for multiple comment icons, wherein the first comment icon is any comment icon in multiple comment icons.

For the apparatus described above, in one embodiment, the interactive information generation module comprises: a first generation sub-module, configured to generate, based on the interactive attributes, at least one of an overall icon input time density graph for multiple comment icons or a first icon input time density graph for the one or a plurality of first comment icons; and the interactive information display module comprises: a first display sub-module, configured to display at least one of the overall icon input time density graph or the first icon input time density graph.

For the apparatus described above, in one embodiment, the interactive information generation module comprises: a first determining sub-module, configured to determine, based on the interactive attributes, a second comment icon having the greatest input time density in a first time interval during playback of the multimedia resource; and a second determining sub-module, configured to determine a second icon input time density graph for the second comment icon for multiple first time intervals during playback of the multimedia resource; and the interactive information display module comprises: a second display sub-module, configured to display the second icon input time density graph.

For the apparatus described above, in one embodiment, the second display sub-module comprises: a third display sub-module, configured to display, for each first time interval in the second icon input time density graph, a second comment icon corresponding to the first time interval and an input time density of the second comment icon.

For the apparatus described above, in one embodiment, the apparatus further comprises: a progress jumping module, configured to, if the displayed visualized interactive information is triggered, cause playing progress of the multimedia resource to jump to a time point corresponding to a location where the visualized interactive information is triggered.

For the apparatus described above, in one embodiment, the interactive information display module comprises at least one of the following display modes: displaying the visualized interactive information in a superimposed manner in a multimedia resource playing region; displaying the visualized interactive information in a multimedia resource playing progress control region; and displaying the visualized interactive information in a region other than the multimedia resource playing region and the multimedia resource playing progress control region.

For the apparatus described above, in one embodiment, the comment icons comprise comment icons in bullet screens.

According to another aspect of the disclosure, an apparatus for displaying interactive attributes is provided, comprising: a processor; and a memory configured to store processor-executable instructions, wherein the processor is configured to: determine interactive attributes regarding a multimedia resource based on interactive data of a user during playback of the multimedia resource; generate visualized interactive information based on the interactive attributes; and display the visualized interactive information.

According to another aspect of the disclosure, a non-volatile computer-readable storage medium is provided, wherein when instructions in the storage medium are executed by a processor of a terminal or a server (or combination thereof), the terminal or the server (or combination thereof) is enabled to perform the method described above, the method comprising: determining interactive attributes regarding a multimedia resource based on interactive data of a user during playback of the multimedia resource; generating visualized interactive information based on the interactive attributes; and displaying the visualized interactive information.

In the method and apparatus for displaying interactive attributes according to embodiments of the disclosure, interactive attributes can be determined based on interactive data of a user during playback of a multimedia resource, and then visualized interactive information is generated and displayed, to clearly and intuitively display interactions, improve the display effect, and enhance user experience.

Other features and aspects of the disclosure will become apparent from the following detailed description of exemplary embodiments with reference to the accompanying drawings.

### BRIEF DESCRIPTION OF THE DRAWINGS

The accompanying drawings which are incorporated in and constitute a part of the disclosure that, together with the description, illustrate exemplary embodiments, features, and aspects of the disclosure, and explain the principles of the disclosure.

FIG. 1 is a flow diagram illustrating a method for displaying interactive attributes shown according to some embodiments of the disclosure.

FIG. 2 is a flow diagram illustrating a method for displaying interactive attributes shown according to some embodiments of the disclosure.

FIG. 3 is a flow diagram illustrating a method for displaying interactive attributes shown according to some embodiments of the disclosure.

FIG. 4 is a flow diagram illustrating a method for displaying interactive attributes shown according to some embodiments of the disclosure.

FIG. 5 is a flow diagram illustrating a method for displaying interactive attributes shown according to some embodiments of the disclosure.

FIG. 6 is a screen diagram of an exemplary application scenario of a method for displaying interactive attributes shown according to some embodiments of the disclosure.

FIG. 7 is a screen diagram of an exemplary application scenario of a method for displaying interactive attributes shown according to some embodiments of the disclosure.

FIG. 8 is a block diagram of an apparatus for displaying interactive attributes shown according to some embodiments of the disclosure.

FIG. 9 is a block diagram of an apparatus for displaying interactive attributes shown according to some embodiments of the disclosure.

FIG. 10 is a block diagram of an apparatus for displaying interactive attributes shown according to some embodiments of the disclosure.

FIG. 11 is a block diagram of an apparatus for displaying interactive attributes shown according to some embodiments of the disclosure.

FIG. 12 is a block diagram of an apparatus for displaying interactive attributes shown according to some embodiments of the disclosure.

### DETAILED DESCRIPTION

Various exemplary embodiments, features, and aspects of the disclosure will be described in detail below with reference to the accompanying drawings. The same reference signs in the accompanying drawings represent elements having the same or similar functions. While the various aspects of the embodiments are shown in the accompanying drawings, the drawings are not necessarily drawn to scale unless specifically indicated. The word “exemplary” used exclusively herein means “serving as an example, embodiment, or illustration.” Any embodiment described herein as “exemplary” is not necessarily to be construed as preferred or advantageous over other embodiments. Further detail is given in the detailed description of the embodiments hereinafter to better illustrate the disclosure. Those skilled in the art should understand that the disclosure can be implemented as well even if certain concrete details are absent. In some examples, the methods, means, elements, and circuits well known to those skilled in the art are not described in detail, to highlight the theme of the disclosure.

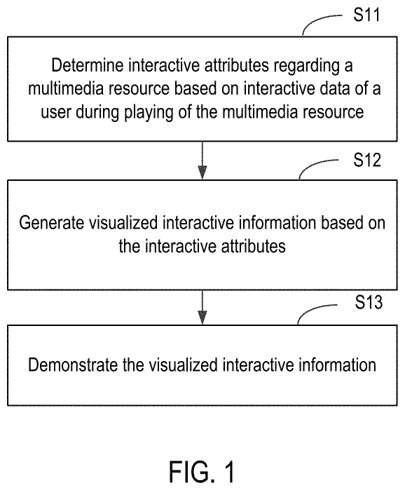

FIG. 1 is a flow diagram illustrating a method for displaying interactive attributes shown according to some embodiments of the disclosure. In some embodiments, the method can be implemented on a terminal device (e.g., a smartphone) or a server. As shown in FIG. 1, the method for displaying interactive attributes according to some embodiments of the disclosure includes the following steps.

Step S11: determine interactive attributes regarding a multimedia resource based on interactive data of a user during playback of the multimedia resource.

Step S12: generate visualized interactive information based on the interactive attributes.

Step S13: display the visualized interactive information.

In some embodiments, interactive attributes can be determined based on interactive data of a user during playback of a multimedia resource, and then visualized interactive information is generated and displayed, to clearly and intuitively display interactions, improve the display effect, and enhance user experience.

The interactive data may be interactive data generated through any interaction, such as making comments, giving likes, or forwarding, performed by the user on a multimedia resource or other objects such as another user during playback of the multimedia resource. The interactive attributes may be any values, statistics, classification results, or the like capable of representing attributive characteristics of the interaction of the user.

For example, during playback of a multimedia resource (e.g., a video), the user may input a comment, which may be a comment on the whole multimedia resource, or a comment on a segment of the multimedia resource or at a certain time point of the playback of the multimedia resource. The content of the comment may include inputting texts, pictures, emoticons, or the like. Further, the comment may be displayed in a special comment display region, or the comment may be displayed on a playing interface of the multimedia resource through bullet screens (or other mechanism allowing for social commenting on multimedia files). The content of the comment input by the user, the input method, and the display mode are all not limited in the disclosure.

In one embodiment, comment icons may include comment icons in bullet screens. The comment icons in bullet screens may include emoticons expressing sadness, happiness, shock, and the like, and the user may input these emoticons in an input method such as clicking a mouse or touching a capacitive touch screen.

In one embodiment, the interactive data may include comment icons input by the user during playback of the multimedia resource and corresponding input time. During playback of the multimedia resource, the comment icons input by the user, for example, comment icons expressing sadness, happiness, and shock clicked by the user, may be acquired. The comment icons input by the user may be input in real time, and may be displayed on the playing interface of the multimedia resource through bullet screens. Using these methods, the comment icons input by the user and the corresponding input time can be acquired as the interactive data.

In one embodiment, the interactive attributes include at least one of an input time distribution of a first comment icon or an overall input time distribution for multiple comment icons, where the first comment icon is any comment icon in multiple comment icons.

For example, interactive attributes regarding a multimedia resource can be determined based on interactive data of the user during playback of the multimedia resource. The interactive attributes may be icon click information of the user obtained by analyzing various types of comment icons input by the user during playback of the multimedia resource, for example, a click time distribution of the same type of icons (the input time distribution of the first comment icon) and a click time distribution of multiple icons (the overall input time distribution for multiple comment icons). The multiple comment icons may include some or all comment icons expressing sadness, happiness, shock, and the like that are provided on the playing interface of the multimedia resource; the first comment icon may include any comment icon expressing sadness, happiness, shock, or the like that is provided on the playing interface of the multimedia resource.

In one embodiment, visualized interactive information may be generated based on the interactive attributes. The visualized interactive information may be a graph generated according to the interactive attributes (e.g., an input time distribution of the comment icons). For example, an input time distribution graph of a first comment icon, an overall input time distribution graph of multiple comment icons, a first icon input time density graph of the one or a plurality of first comment icons, an overall icon input time density graph of multiple comment icons, or the like may be generated. Moreover, the generated graph may be, for example, a line graph, a curve graph, or a grayscale heat map, a color heat map, or the like, which are not limited in the disclosure.

In one embodiment, step S13 may include at least one of the following display methods: (1) displaying the visualized interactive information in a superimposed manner in a multimedia resource playing region; (2) displaying the visualized interactive information in a multimedia resource playing progress control region; or (3) displaying the visualized interactive information in a region other than the multimedia resource playing region and the multimedia resource playing progress control region.

For example, the visualized interactive information may be displayed. The visualized interactive information may be displayed at a specific location on a screen. For example, the overall input time distribution graph of the multiple comment icons may be displayed in a superimposed manner in a transparent color in a multimedia resource playing region; displayed in a multimedia resource playing progress control region, displayed in an independent region other than the playing region and the progress control region; or the like. The display method of the visualized interactive information is not limited in the disclosure.

In one embodiment, the size of the visualized interactive information may be processed to display the visualized interactive information in the multimedia resource playing progress control region. For example, horizontal and vertical axes of the overall icon input time density graph of the multiple comment icons may be adjusted (the vertical axis is compressed and the horizontal axis is stretched) to adapt to the size of the multimedia resource playing progress control region, to display the overall icon input time density graph in the multimedia resource playing progress control region (e.g., a video playing progress control bar). When the overall icon input time density graph is a curve graph, the user can directly view a time density peak of the curve graph; when the overall icon input time density graph is a grayscale heat map (e.g., the greater the time density, the darker the color), the user can directly view the image grayscale to determine a time density peak. Using these methods, the user can intuitively view the icon input time density at different resource playing progress, so that the user can continue watching or jump to a location of interest.

In one embodiment, visualized interactive information can be acquired after classification and statistical analysis are performed on interactive data (e.g., icon information in bullet screen information); the visualized interactive information is shared and displayed; and classified display can be performed during playback of a multimedia resource, so that content is shared and displayed more precisely with a clearer hierarchy.

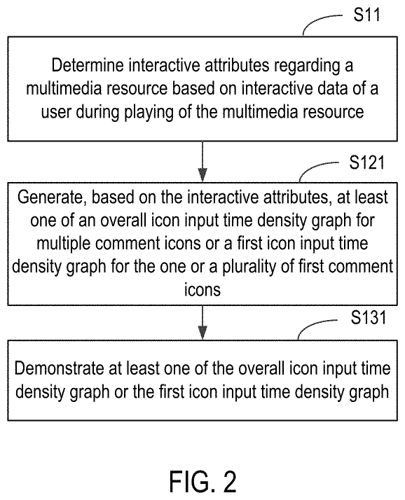

FIG. 2 is a flow diagram illustrating a method for displaying interactive attributes shown according to some embodiments of the disclosure. As shown in FIG. 2, in one embodiment, step S12 (described previously) includes the following sub-steps.

Step S121: generate, based on the interactive attributes, at least one of an overall icon input time density graph for multiple comment icons or a first icon input time density graph for the one or a plurality of first comment icons.

Step S131: display at least one of the overall icon input time density graph or the first icon input time density graph.

For example, according to interactive attributes, for example, at least one of an input time distribution of a first comment icon or an overall input time distribution for multiple comment icons, the interactive attributes may be analyzed to acquire at least one of an overall icon input time density graph for multiple comment icons or a first icon input time density graph for one or a plurality of first comment icons and the like, to intuitively reflect the input status of comment icons at a certain time point or in a certain time period. For example, the user clicks comment icons of smiley faces more frequently from the fifth minute to the seventh minute during playback of the multimedia resource; then, the comment icons of smiley faces are denser in this time period in an icon input time density graph, and the multimedia resource is likely to have more funny pictures in this time period.

In one embodiment, an overall icon input time density graph for multiple comment icons may be displayed. The multiple comment icons may all be comment icons or some comment icons selected from all the comment icons, and the selected partial comment icons may be a system default or selected by the user. For example, the user may select comment icons expressing sadness, happiness, and shock in all the comment icons, to display an overall icon input time density graph of the comment icons expressing sadness, happiness, and shock. The overall icon input time density graph may be displayed, for example, in a superimposed manner in a transparent color in the multimedia resource playing region. Using these methods, when watching the multimedia resource, the user can view information such as the attention level and excitement level of the subsequent content (e.g., a great icon input time density may indicate a high attention level) to be attracted to continue watching.

In one embodiment, a first icon input time density graph for one or a plurality of first comment icons may be displayed. An input time density of the one or a plurality of first comment icons may be displayed in the icon input time density graph. The multiple first comment icons may be all comment icons or some comment icons selected from all the comment icons, and the selected partial comment icons may be a system default or selected by the user. For example, the user may select comment icons expressing sadness, happiness, and shock in all the comment icons, to display input time density graphs of the comment icons expressing sadness, happiness, and shock in the first icon input time density graph. The first icon input time density graph may be displayed, for example, in a superimposed manner in a transparent color in the multimedia resource playing region. Using these methods, when watching the multimedia resource, the user can view information such as the attention level and content tendency of the subsequent content (e.g., a great input time density of the icon expressing happiness and a small input time density of the icon expressing shock/sadness indicate that the content is likely to be funny) to be attracted to continue watching.

Using the above methods, the interactions can be displayed clearly and intuitively, and the display effect can be improved.

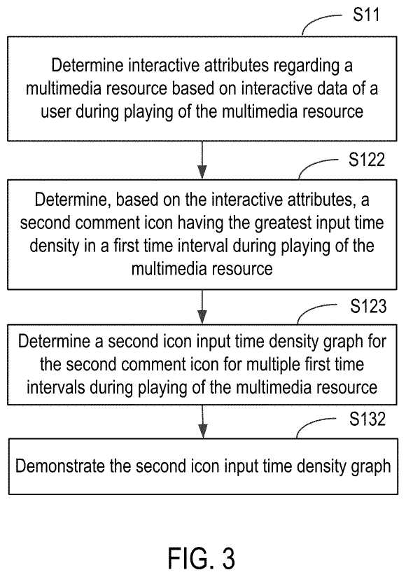

FIG. 3 is a flow diagram illustrating a method for displaying interactive attributes shown according to some embodiments of the disclosure. As shown in FIG. 3, in one embodiment, step S12 (described previously) includes the following steps.

Step S122: determine, based on the interactive attributes, a second comment icon having the greatest input time density in a first time interval during playback of the multimedia resource.

Step S123: determine a second icon input time density graph for the second comment icon for multiple first time intervals during playback of the multimedia resource.

Step S132: display the second icon input time density graph.

For example, according to interactive attributes, for example, at least one of an input time distribution of a first comment icon or an overall input time distribution for multiple comment icons, the interactive attributes in a first time interval during playback of the multimedia resource may be analyzed to determine a second comment icon having the greatest input time density (the greatest weight) in the first time interval. For example, the user clicks mostly a comment icon expressing happiness among comment icons expressing sadness, happiness, shock, and the like from the fifth minute to the seventh minute during playback of the multimedia resource; then, the comment icon of happiness has the greatest input time density, and the comment icon expressing happiness may be determined as the second comment icon in the time interval.

In one embodiment, the multiple analyzed comment icons may be all comment icons or some comment icons in all the comment icons, and the selected partial comment icons may be a system default or selected by the user. For example, from among all the comment icons, the user may remove a comment icon expressing shock that he does not want to focus on.

In one embodiment, for multiple first time intervals during playback of the multimedia resource, a second comment icon for each of the multiple first time intervals may be determined, and then a second icon input time density graph for the second comment icon may be determined, and the second icon input time density graph may be displayed. For example, the second comment icon is a comment icon of happiness from the fifth minute to the seventh minute during playback of the multimedia resource; the second comment icon is a comment icon of sadness from the seventh minute to the tenth minute; and the second comment icon is a comment icon of shock from the tenth minute to the fourteenth minute. Then, input time densities of the comment icons of happiness, sadness, and shock are respectively displayed from the fifth minute to the seventh minute, from the seventh minute to the tenth minute, and from the tenth minute to the fourteenth minute in the second icon input time density graph. Using these methods, when watching the multimedia resource, the user can view information such as the attention level and content tendency of the subsequent content (e.g., the content from the fifth minute to the seventh minute is likely to be funny) to be attracted to continue watching.

Using these methods, the interactions can be displayed clearly and intuitively, and the display effect can be improved.

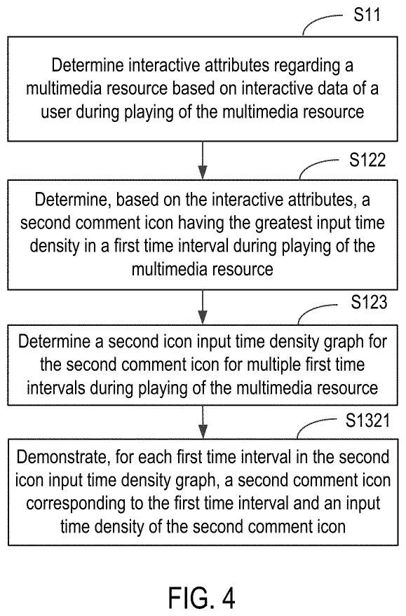

FIG. 4 is a flow diagram illustrating a method for displaying interactive attributes shown according to some embodiments of the disclosure. As shown in FIG. 4, in one embodiment, step S132 (discussed previously) includes the following step.

Step S1321: display, for each first time interval in the second icon input time density graph, a second comment icon corresponding to the first time interval and an input time density of the second comment icon.

For example, for each time interval in multiple first time intervals during playback of the multimedia resource, a second comment icon for each time interval may be determined, and then for each first time interval, a second comment icon corresponding to the first time interval and an input time density of the second comment icon may be determined and displayed. For example, different types of icons may be represented by different colors or grayscales. For example, shock is represented by blue and happiness is represented by yellow. When the comment icon of shock has the greatest weight (the greatest input time density) at a certain moment (in the first time interval), the second comment icon is determined as the comment icon of shock, and blue is presented at the moment (the first time interval).

In one embodiment, density graphs of various types of comment icons may also be separately displayed according to the user's selection. For example, only input time densities of some comment icons in all the comment icons in the first time interval are analyzed, to determine the second comment icon. The selected partial comment icons may be a system default or selected by the user.

Using these methods, the tendency of the interactions can be displayed clearly and intuitively, and the display effect can be improved.

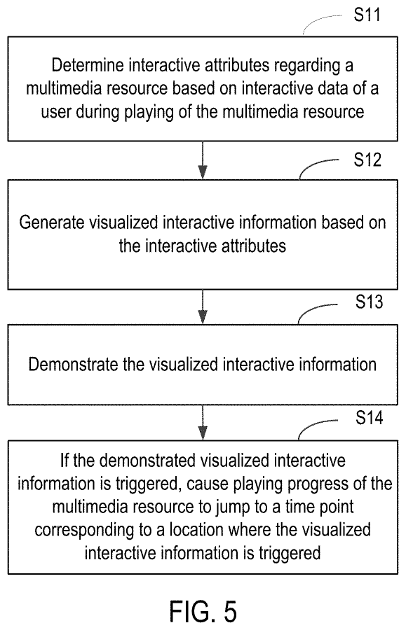

FIG. 5 is a flow diagram illustrating a method for displaying interactive attributes shown according to some embodiments of the disclosure. As shown in FIG. 5, in one embodiment, the methods described, for example, in FIG. 1 further include the following step.

Step S14: if the displayed visualized interactive information is triggered, cause playing progress of the multimedia resource to jump to a time point corresponding to a location where the visualized interactive information is triggered.

For example, when visualized interactive information is being displayed, the content in the displayed visualized interactive information may be set as triggerable. For example, when the user clicks an overall icon input time density graph (visualized interactive information) on the screen, the overall icon input time density graph may be triggered. According to the location of the visualized interactive information triggered by the user, a corresponding operation may be performed, for example, causing playing progress of the multimedia resource to jump to a time point corresponding to a location where the visualized interactive information is triggered. For example, when the user clicks to trigger the location of a time density peak of the overall icon input time density graph, playing progress of a video may jump to a time point corresponding to the time density peak, so that the user can directly view the video content at the time point and user operation is more convenient.

In one embodiment, when the visualized interactive information is displayed in a superimposed manner in a multimedia resource playing region, or the visualized interactive information is displayed in a region other than the multimedia resource playing region and the multimedia resource playing progress control region, the time of the visualized interactive information may have a one-to-one correspondence with the time of the video playing progress, so that a corresponding jump in the playing progress can be performed when the user triggers the visualized interactive information. When the visualized interactive information is displayed in the multimedia resource playing progress control region, the time of the visualized interactive information may coincide with the time of the video playing progress, so that the visualized interactive information is triggered when the user clicks a video playing progress icon, and thus the triggering of the visualized interactive information is synchronous to the jump in the playing progress.

Using these methods, a jump in the playing progress can be performed by triggering visualized interactive information while interactions are displayed intuitively, thereby further improving convenience in user operation and enhancing user experience.

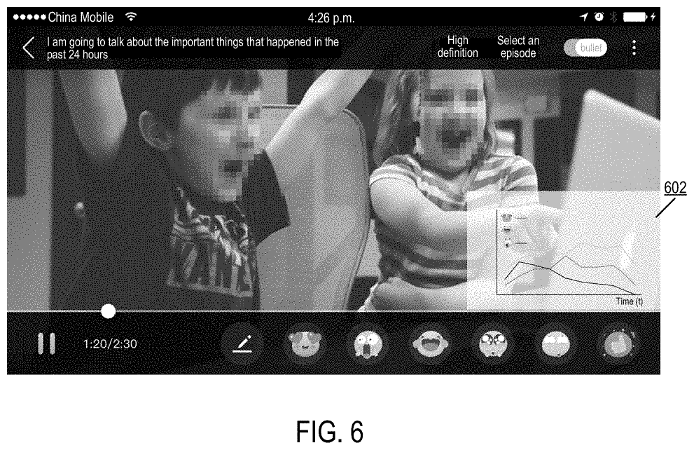

FIG. 6 is a screen diagram of an exemplary application scenario of a method for displaying interactive attributes shown according to some embodiments of the disclosure. As shown in FIG. 6, in this exemplary application scenario, visualized interactive information (602) may be displayed in a superimposed manner in a transparent color in the lower right corner of the video playing region. The visualized interactive information may include input time density graphs of comment icons expressing love, happiness (tears of joy), and shock respectively. The input time density is represented by a broken line. Different comment icons are represented by different colors/grayscales. Using these methods, it can be seen from the input time density graphs that the comment icon of happiness has a great input time density, and the comment icon of shock has a small input time density, so that the user learns that the video may include lots of funny content, and users who like funny content are attracted to continue watching.

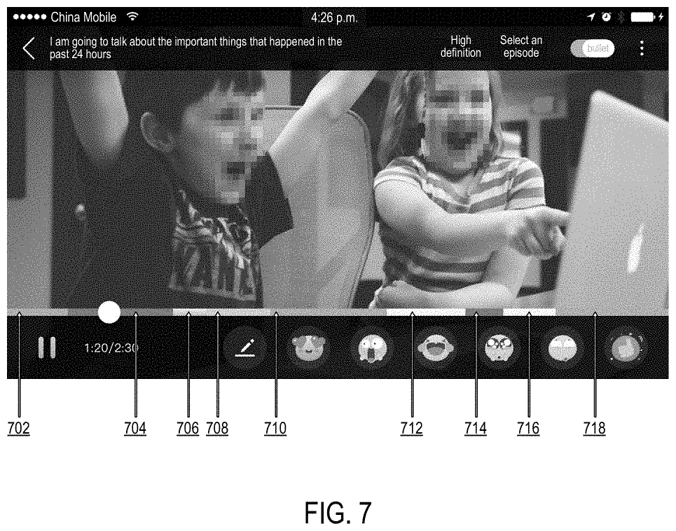

FIG. 7 is a screen diagram of an exemplary application scenario of a method for displaying interactive attributes shown according to some embodiments of the disclosure. As shown in FIG. 7, in this exemplary application scenario, visualized interactive information may be displayed in a video playing progress control region. The whole region of the video playing progress may be divided into multiple first time intervals (702-718), a second comment icon having the greatest weight in each of the multiple first time intervals is acquired, and then for each first time interval, the second comment icon corresponding to the first time interval can be displayed. Different types of icons may be represented by different colors/grayscales, for example, shock is represented by dark gray and happiness is represented by light gray, so that the playing progress control region (the first time interval) where the comment icon of shock has the greatest weight is displayed in dark gray, and the playing progress control region (the first time interval) where the comment icon of happiness has the greatest weight is displayed in light gray.

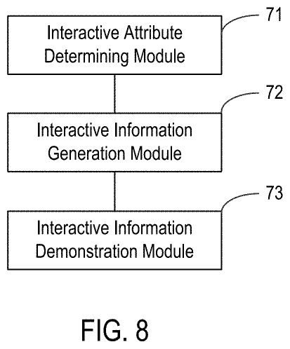

FIG. 8 is a block diagram of an apparatus for displaying interactive attributes shown according to some embodiments of the disclosure. As shown in FIG. 8, the apparatus for displaying interactive attributes includes an interactive attribute determining module 71, an interactive information generation module 72, and an interactive information display module 73.

The interactive attribute determining module 71 is configured to determine interactive attributes regarding a multimedia resource based on interactive data of a user during playback of the multimedia resource.

The interactive information generation module 72 is configured to generate visualized interactive information based on the interactive attributes.

The interactive information display module 73 is configured to display the visualized interactive information. In one embodiment, the interactive data includes comment icons input by the user during playback of the multimedia resource and corresponding input time. The interactive attributes include at least one of an input time distribution of a first comment icon or an overall input time distribution for multiple comment icons. The first comment icon is any comment icon in multiple comment icons.

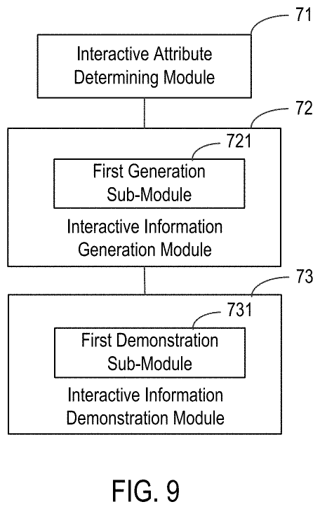

FIG. 9 is a block diagram of an apparatus for displaying interactive attributes shown according to some embodiments of the disclosure. As shown in FIG. 9, in one embodiment, the interactive information generation module 72 includes a first generation sub-module 721, configured to generate, based on the interactive attributes, at least one of an overall icon input time density graph for multiple comment icons or a first icon input time density graph for the one or a plurality of first comment icons.

As shown in FIG. 9, in one embodiment, the interactive information display module 73 includes a first display sub-module 731, configured to display at least one of the overall icon input time density graph or the first icon input time density graph.

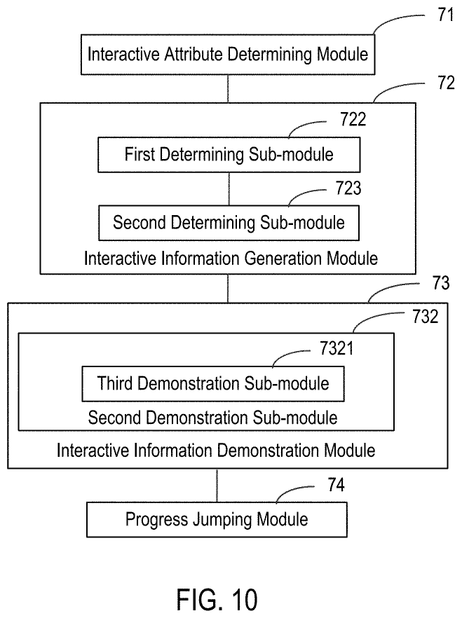

FIG. 10 is a block diagram of an apparatus for displaying interactive attributes shown according to some embodiments of the disclosure. As shown in FIG. 10, in one embodiment, the interactive information generation module 72 includes a first determining sub-module 722 and a second determining sub-module 723.

The first determining sub-module 722 is configured to determine, based on the interactive attributes, a second comment icon having the greatest input time density in a first time interval during playback of the multimedia resource.

The second determining sub-module 723 is configured to determine a second icon input time density graph for the second comment icon for multiple first time intervals during playback of the multimedia resource.

As shown in FIG. 10, in one embodiment, the interactive information display module 73 includes a second display sub-module 732, configured to display the second icon input time density graph.

As shown in FIG. 10, in one embodiment, the second display sub-module 732 includes a third display sub-module 7321, configured to display, for each first time interval in the second icon input time density graph, a second comment icon corresponding to the first time interval and an input time density of the second comment icon.

As shown in FIG. 10, in one embodiment, the apparatus further includes a progress jumping module 74, configured to, if the displayed visualized interactive information is triggered, cause playing progress of the multimedia resource to jump to a time point corresponding to a location where the visualized interactive information is triggered.

In one embodiment, the interactive information display module 73 includes at least one of the following display methods: (1) displaying the visualized interactive information in a superimposed manner in a multimedia resource playing region; (2) displaying the visualized interactive information in a multimedia resource playing progress control region; and (3) displaying the visualized interactive information in a region other than the multimedia resource playing region and the multimedia resource playing progress control region.

In one embodiment, the comment icons include comment icons in bullet screens.

In the method and apparatus for displaying interactive attributes according to the embodiments of the disclosure, interactive attributes can be determined based on interactive data of a user during playback of a multimedia resource, and then visualized interactive information is generated and displayed, to clearly and intuitively display interactions, improve the display effect, and enhance user experience.

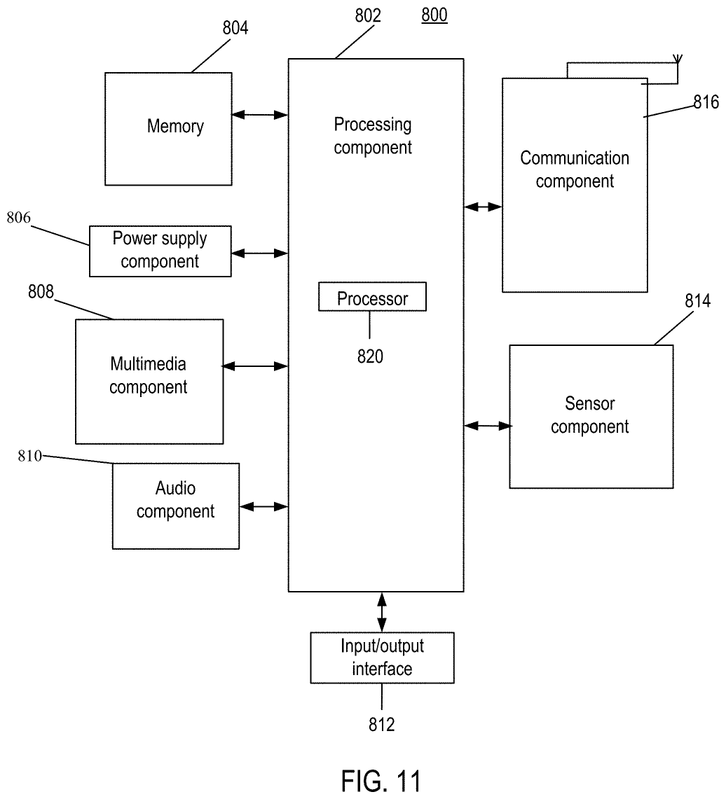

FIG. 11 is a block diagram of an apparatus 800 for displaying interactive attributes shown according to some embodiments of the disclosure. For example, the apparatus 800 may be a mobile phone, a computer, a digital broadcasting terminal, a message transceiver device, a game console, a tablet device, a medical device, a fitness device, a personal digital assistant, or the like.

Referring to FIG. 11, the apparatus 800 may include one or a plurality of the following components: a processing component 802, a memory 804, a power supply component 806, a multimedia component 808, an audio component 810, an input/output (I/O) interface 812, a sensor component 814, and a communication component 816.

The processing component 802 typically controls overall operations of the apparatus 800, such as operations associated with display, telephone calls, data communications, camera operations, and recording operations. The processing component 802 may include one or a plurality of processors 820 to execute instructions to perform all or part of the steps in the method described above. Moreover, the processing component 802 may include one or a plurality of modules which facilitate the interaction between the processing component 802 and other components. For example, the processing component 802 may include a multimedia module to facilitate the interaction between the multimedia component 808 and the processing component 802.

The memory 804 is configured to store various types of data to support the operation on the apparatus 800. Examples of such data include instructions for any applications or methods operated on the apparatus 800, contact data, phonebook data, messages, pictures, videos, and the like. The memory 804 may be implemented using any type of volatile or non-volatile storage devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power supply component 806 supplies power to various components of the apparatus 800. The power supply component 806 may include a power management system, one or a plurality of power sources, and other components associated with the generation, management, and distribution of power for the apparatus 800.

The multimedia component 808 includes a screen providing an output interface between the apparatus 800 and a user. In some embodiments, the screen may include a liquid crystal display (LCD) and a touch panel (TP). If the screen includes the touch panel, the screen may be implemented as a touch screen to receive input signals from the user. The touch panel includes one or a plurality of touch sensors to sense touches, swipes, and gestures on the touch panel. The touch sensors may not only sense a boundary of a touch or swipe action, but also detect a period of time and a pressure related to the touch or swipe operation. In some embodiments, the multimedia component 808 includes a front camera or a rear camera or, in some embodiments, both a front or rear camera. Either the front camera or the rear camera (or both) may receive external multimedia data while the apparatus 800 is in an operation mode, such as a photographing mode or a video mode. Each of the front camera and the rear camera may be a fixed optical lens system or have focus and optical zoom capability.

The audio component 810 is configured to output or input audio signals. For example, the audio component 810 includes a microphone (MIC) configured to receive an external audio signal when the apparatus 800 is in an operation mode, such as a call mode, a recording mode, and a voice recognition mode. The received audio signal may be further stored in the memory 804 or sent via the communication component 816. In some embodiments, the audio component 810 further includes a speaker to output audio signals.

The I/O interface 812 provides an interface between the processing component 802 and peripheral interface modules that may be a keyboard, a click wheel, buttons, and the like. The buttons may include, but are not limited to, a home button, a volume button, a starting button, and a locking button.

The sensor component 814 includes one or a plurality of sensors to provide state assessment of various aspects for the apparatus 800. For example, the sensor component 814 may detect an on/off state of the apparatus 800, and relative positioning of components, for example, a display and a keypad of the apparatus 800; the sensor component 814 may further detect a change in position of the apparatus 800 or a component of the apparatus 800, presence or absence of user contact with the apparatus 800, an orientation or an acceleration/deceleration of the apparatus 800, and a change in temperature of the apparatus 800. The sensor component 814 may include a proximity sensor configured to detect the presence of nearby objects without any physical contact. The sensor component 814 may further include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate communication in wired or wireless manner between the apparatus 800 and other devices. The apparatus 800 can access a wireless network based on a communication standard, such as WiFi, 2G, or 3G, or a combination thereof. In one exemplary embodiment, the communication component 816 receives a broadcast signal or broadcast-related information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an Infrared Data Association (IrDA) technology, an ultra-wideband (UWB) technology, a Bluetooth (BT) technology, and other technologies.

In an exemplary embodiment, the apparatus 800 may be implemented by one or a plurality of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the method described above.

In an exemplary embodiment, a non-volatile computer-readable storage medium including instructions is also provided, such as the memory 804 including instructions, where the instructions are executable by the processor 820 of the apparatus 800 to perform the method described above.

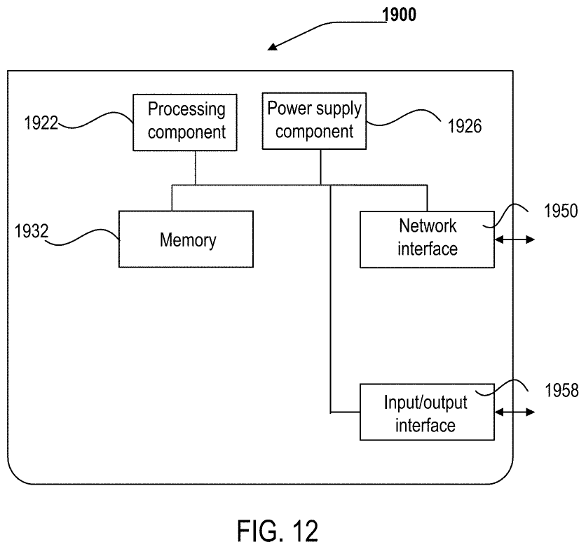

FIG. 12 is a block diagram of an apparatus 1900 for displaying interactive attributes shown according to some embodiments of the disclosure. For example, the apparatus 1900 may be provided as a server. Referring to FIG. 12, the apparatus 1900 includes a processing component 1922 that further includes one or a plurality of processors, and a memory resource represented by a memory 1932 configured to store instructions executable by the processing component 1922, such as an application. The application stored in the memory 1932 may include one or a plurality of modules each corresponding to a set of instructions. In addition, the processing component 1922 is configured to execute instructions to perform the method described above.

The apparatus 1900 may further include a power supply component 1926 configured to perform power management for the apparatus 1900, a wired or wireless network interface 1950 configured to connect the apparatus 1900 to the network, and an input/output (I/O) interface 1958. The apparatus 1900 may operate based on an operating system stored in the memory 1932, such as Windows Server®, Mac OS X®, Unix®, Linux®, FreeBSD®, or the like.

In an exemplary embodiment, a non-volatile computer-readable storage medium including instructions is also provided, such as the memory 1932 including instructions, where the instructions are executable by the processing component 1922 of the apparatus 1900 to perform the method described above.

The disclosed embodiments may comprise one or more of a system, a method or a computer program product. The computer program product may include a computer-readable storage medium, having computer-readable program instructions thereon for allowing a processor to implement various aspects of the disclosure.

The computer-readable storage medium can be a tangible device that can hold and store instructions used by an instruction execution device. The computer-readable storage medium may be, for example, but is not limited to an electrical storage device, a magnetic storage device, an optical storage device, an electromagnetic storage device, a semiconductor memory device, or any suitable combination thereof. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanical coding device, such as a punch card with instructions stored thereon or a structure of bumps within recessions, and any suitable combination thereof. The computer-readable storage medium used herein is not interpreted as transient signals themselves, such as radio waves or other freely propagated electromagnetic waves, electromagnetic waves propagated through a waveguide or other transmission media (e.g., light pulses passing through a fiber optic cable), or electrical signals transmitted through electric wires.

The computer-readable program instructions described herein may be downloaded from a computer-readable storage medium to various computing/processing devices or downloaded to an external computer or external storage device via a network such as the Internet, a local area network, a wide area network or a wireless network. The network may include copper transmission cables, fiber transmission, wireless transmission, routers, firewalls, switches, gateway computers, or edge servers. A network adapter card or a network interface in each computing/processing device receives computer-readable program instructions from the network and forwards the computer-readable program instructions, for storing them in a computer-readable storage medium in each computing/processing device.

Computer program instructions for performing the operations of the disclosure can be assembly instructions, instruction set architecture (ISA) instructions, machine instructions, machine related instructions, microcode, firmware instructions, state setting data, or source code or object code written in any combination of one or a plurality of programming languages, the programming language including object oriented programming languages such as Smalltalk, C++ and the like, and conventional procedural programming languages such as “C” language or similar programming languages. The computer-readable program instructions can be executed entirely or partly on a user computer, executed as a stand-alone software package, executed partly on a user computer and partly on a remote computer, or executed entirely on a remote computer or server. In the case of a remote computer, the remote computer may be connected to the user's computer through any kind of network, including a local area network (LAN) or a wide area network (WAN). Alternatively, it can be connected to an external computer (e.g., using an Internet service provider to connect via the Internet). In some embodiments, an electronic circuit, for example, a programmable logic circuit, a field-programmable gate array (FPGA), or a programmable logic array (PLA), may execute the computer-readable program instructions by utilizing state information of the computer-readable program instructions to personalize the electronic circuit, in order to implement various aspects of the disclosure

Various aspects of the disclosure are described herein with reference to flowcharts or block diagrams of the method, apparatus (system), and computer program product according to the embodiments of the disclosure. It should be understood that, each block of the flowcharts and block diagrams and combinations of various blocks in the flowcharts and block diagrams can be implemented by computer-readable program instructions.

These computer-readable program instructions may be provided to a processor of a general-purpose computer, a special-purpose computer or other programmable data processing apparatuses, to produce a machine, so that these instructions, when executed by the processor of the computer or other programmable data processing apparatuses, produce an apparatus for implementing the functions/actions specified in one or a plurality of blocks of the flowcharts and block diagrams. Also, these computer-readable program instructions may be stored in a computer-readable storage medium. These instructions allow a computer, a programmable data processing apparatus, or other devices to work in a specific manner; thus, the computer-readable medium storing the instructions includes an artifact, including instructions that implement various aspects of the functions/actions specified in one or a plurality of blocks of the flowcharts and block diagrams.

The computer-readable program instructions may also be loaded onto a computer, other programmable data processing apparatuses, or other devices, such that the computer, other programmable data processing apparatuses or other devices perform a series of operational steps, to generate a computer-implemented process, such that the functions/actions specified in one or a plurality of blocks of the flowcharts and block diagrams are implemented by the instructions executed on the computer, other programmable data processing apparatuses, or other devices.

The flowcharts and block diagrams in the accompanying drawings illustrate system architectures, functions, and operations of embodiments of the system, method, and computer program product according to multiple embodiments of the disclosure. In this regard, each block in the flowcharts or block diagrams may represent a portion of a module, program segment, or instruction that contains one or a plurality of executable instructions for implementing the specified logical functions. In some alternative implementations, the functions denoted in the blocks can also occur in a different order than that illustrated in the drawings. For example, two consecutive blocks can actually be performed substantially in parallel, sometimes can also be performed in a reverse order, depending upon the functions involved. It is also noted that each block of the block diagrams and flowcharts, and combinations of blocks in the block diagrams and flowcharts can be implemented in a dedicated hardware-based system that performs the specified function or action, or can be implemented by a combination of dedicated hardware and computer instructions.

The embodiments of the disclosure have been described above, and the foregoing description is exemplary rather than exhaustive, and is not limited to the disclosed embodiments. Numerous modifications and variations will be apparent to those of ordinary skill in the art without departing from the scope and spirit of the illustrated embodiments. The terminology used herein was chosen to best explain the principles of the embodiments, the practical application or technical improvement over the technologies found in the marketplace, or to enable others of ordinary skill in the art to understand the embodiments disclosed herein.

1-17. (canceled)

18. A method comprising:
determining interactive attributes regarding a multimedia resource based on interactive data of a user input during playback of the multimedia resource;
generating visualized interactive information based on the interactive attributes; and
displaying the visualized interactive information during subsequent playback of the multimedia resource.

19. The method of claim 18, the interactive data comprising comment icons and corresponding input times, the interactive attributes comprising at least one of an input time distribution of a first comment icon or an overall input time distribution for multiple comment icons.

20. The method of claim 19, the comment icons comprising comment icons in a bullet screen.

21. The method of claim 19, the generating visualized interactive information comprising at least one of:
generating, based on the interactive attributes, an overall icon input time density graph for multiple comment icons; or
generating, based on the interactive attributes, a first icon input time density graph for the one or a plurality of first comment icons.

22. The method of claim 19, the generating visualized interactive information comprising:
determining, based on the interactive attributes, a second comment icon having the greatest input time density in a first time interval during playback of the multimedia resource; and
determining a second icon input time density graph for the second comment icon for multiple first time intervals during playback of the multimedia resource.

23. The method of claim 22, the displaying the visualized interactive information comprising displaying, for each first time interval in the second icon input time density graph, a second comment icon corresponding to the first time interval and an input time density of the second comment icon.

24. The method of claim 18, further comprising causing playing progress of the multimedia resource to jump to a time point corresponding to a location where the visualized interactive information is triggered upon detecting that the displayed visualized interactive information is triggered.

25. The method of claim 18, the displaying the visualized interactive information comprises at least one of:
displaying the visualized interactive information in a superimposed manner in a multimedia resource playing region;
displaying the visualized interactive information in a multimedia resource playing progress control region; or
displaying the visualized interactive information in a region other than the multimedia resource playing region and the multimedia resource playing progress control region.

26. A non-transitory computer readable storage medium for tangibly storing computer program instructions capable of being executed by a computer processor, the computer program instructions defining the steps of:
determining interactive attributes regarding a multimedia resource based on interactive data of a user input during playback of the multimedia resource;
generating visualized interactive information based on the interactive attributes; and
displaying the visualized interactive information during subsequent playback of the multimedia resource.

27. The non-transitory computer readable storage medium of claim 26, the interactive data comprising comment icons and corresponding input times, the interactive attributes comprising at least one of an input time distribution of a first comment icon or an overall input time distribution for multiple comment icons.

28. The non-transitory computer readable storage medium of claim 27, the comment icons comprising comment icons in a bullet screen.

29. The non-transitory computer readable storage medium of claim 27, the generating visualized interactive information comprising at least one of:
generating, based on the interactive attributes, an overall icon input time density graph for multiple comment icons; or
generating, based on the interactive attributes, a first icon input time density graph for the one or a plurality of first comment icons.

30. The non-transitory computer readable storage medium of claim 27, the generating visualized interactive information comprising:
determining, based on the interactive attributes, a second comment icon having the greatest input time density in a first time interval during playback of the multimedia resource; and
determining a second icon input time density graph for the second comment icon for multiple first time intervals during playback of the multimedia resource.

31. The non-transitory computer readable storage medium of claim 30, the displaying the visualized interactive information comprising displaying, for each first time interval in the second icon input time density graph, a second comment icon corresponding to the first time interval and an input time density of the second comment icon.

32. The non-transitory computer readable storage medium of claim 26, the computer program instructions further defining the step of causing playing progress of the multimedia resource to jump to a time point corresponding to a location where the visualized interactive information is triggered upon detecting that the displayed visualized interactive information is triggered.

33. The non-transitory computer readable storage medium of claim 26, the displaying the visualized interactive information comprises at least one of:
displaying the visualized interactive information in a superimposed manner in a multimedia resource playing region;
displaying the visualized interactive information in a multimedia resource playing progress control region; or
displaying the visualized interactive information in a region other than the multimedia resource playing region and the multimedia resource playing progress control region.

34. An apparatus comprising:
a processor; and
a storage medium for tangibly storing thereon program logic for execution by the processor, the stored program logic comprising:
logic, executed by the processor, for determining interactive attributes regarding a multimedia resource based on interactive data of a user input during playback of the multimedia resource;
logic, executed by the processor, for generating visualized interactive information based on the interactive attributes; and
logic, executed by the processor, for displaying the visualized interactive information during subsequent playback of the multimedia resource.

35. The apparatus of claim 34, the interactive data comprising comment icons and corresponding input times, the interactive attributes comprising at least one an input time distribution of a first comment icon or an overall input time distribution for multiple comment icons.

36. The apparatus of claim 35, the logic for generating visualized interactive information comprising at least one of:
logic, executed by the processor, for generating, based on the interactive attributes, an overall icon input time density graph for multiple comment icons; or
logic, executed by the processor, for generating, based on the interactive attributes, a first icon input time density graph for the one or a plurality of first comment icons.

37. The apparatus of claim 35, the logic for generating visualized interactive information comprising:
logic, executed by the processor, for determining, based on the interactive attributes, a second comment icon having the greatest input time density in a first time interval during playback of the multimedia resource; and
logic, executed by the processor, for determining a second icon input time density graph for the second comment icon for multiple first time intervals during playback of the multimedia resource.
